(19) United States
(12) Patent Application Publication
(10) Pub. No.: US 2016/0047408 A1
(43) Pub. Date: Feb. 18, 2016

(54) Locking Device

(71) Applicant: Bernd STOCK, Wiesbaden (DE)

(72) Inventor: Bernd Stock, Wiesbaden (DE)

(21) Appl. No.: 14/774,712

(22) PCT Filed: Apr. 29, 2014
(86) PCT No.: PCT/EP2014/058678

§ 371 Date: Sep. 11, 2015

(30) Foreign Application Priority Data
Apr. 30, 2013 (DE) 10 2013 104 389.5

(51) Int. Cl. F16B 21/06; B60B 3/14

(52) U.S. Cl. CPC F16B 21/065; B60B 3/14

(57) ABSTRACT

The invention relates to a locking device having a base body, a locking means for locking the base body to a counter body, an actuation means movable relative to the base body, said actuation means being able to be brought into contact with the locking means, and at least one displacement device. In the case of actuating the actuation means, the displacement device automatically moves the actuation means into a locking position. In the locking position, the actuation means is in contact with the locking means and transfers said actuation means into a locking position.

### CROSS-REFERENCE TO RELATED APPLICATIONS

This application is the U.S. national stage of International Application No. PCT/EP2014/058678 filed on Apr. 29, 2014, and claims the benefit thereof. The international application claims the benefit under 35 USC 119 of German Application No. DE 10 2013 104 389.5 filed on Apr. 30, 2013; all applications are incorporated by reference herein in their entirety.

### BACKGROUND

The invention relates to a locking device.

The use of locking devices for connecting at least two components from a number of technical areas is known from the prior art. It is, for example, known that fastening wheel rims and thus a wheel to wheel axes takes place by means of a plurality of screw connections. The screw connections are arranged in a circular manner around the central axis on the wheel axle. In the case of sports cars, it is known that the connection takes place by means of a single central nut or screw. In DE 61 00 25 A and DE 62 53 10 A, alternative connection types are disclosed, in which a connection of the wheel rim to the wheel axle is achieved by clamping a clamping piece.

The above-mentioned locking devices have the disadvantage that the connection between the components is time-consuming if three to five or more screws or nuts can be loosened and correctly refitted. Furthermore, there is a disadvantage that in order to connect the screws or nuts, a tool such as a torque key is required, which is not always available. In addition, a high degree of effort is required in order to fasten the screws or nuts.

A locking device having the features of the characterising part of the current claim 1 is, for example, known from DE 19 59 884 A. Here a rapid closure for safety belts in vehicles is disclosed, which has a base body and a locking means for locking the base body to a counter body. The rapid closure consists of a sleeve and a locking pin insertable therein having members for cooperating with locking balls arranged in the sleeve, which are retained by a spring-loaded sleeve in a non-locking position and are guided into locking engagement with the locking pin in the case of the locking pin being introduced into the sleeve. Furthermore, a safety member is provided, which prevents a displacement of the sleeve by means of a member other than the locking pin.

However, this rapid closure has the disadvantage that in the case of actuating the actuation means, said actuation means is not automatically transferred into a locking position. In fact, the locking takes place such that in the standby position of the closure, the locking pin is inserted into the sleeve. The head then displaces the sleeve downwards. As soon as the sleeve with its upper edge reaches below the transverse bores, it frees the locking balls so that the latter, if the head of the locking pin has also passed the bores, is compressed into the recess by the spring through cooperation of the ring. The rapid closure is then located in the locking position.

The actuation means is also not automatically moved into the locking position by the displacement device after exceeding a centre point.

### SUMMARY

The invention relates to a locking device having a base body, a locking means for locking the base body to a counter body, an actuation means movable relative to the base body, said actuation means being able to be brought into contact with the locking means, and at least one displacement device. In the case of actuating the actuation means, the displacement device automatically moves the actuation means into a locking position. In the locking position, the actuation means is in contact with the locking means and transfers said actuation means into a locking position.

### DETAILED DESCRIPTION

Thus the object of the invention consists of providing a locking device which is easy to handle and enables a connection between at least two components to be connected without the aforementioned disadvantages occurring.

This object is solved by a locking device, which has a base body, a locking means for locking the base body to the counter body, an actuation means movable relative to the base body, said actuation means being able to be brought into contact with the locking means, and at least one, in particular mechanic, displacement device. The displacement device is in particular directly connected to the actuation means and to the base body and automatically moves the actuation means into a locking position in the case of actuating the actuation means. In the locking position, the actuation means is in contact with the locking means and transfers said actuation means into a locking position. Furthermore, the displacement device automatically moves the actuation means into the locking position only after exceeding a centre point.

Advantageous configurations of the invention are subject matter of the dependent claims.

A locking device designed in this manner has the advantage that in order to achieve the connection between the base body and the counter body, a number of fastening means, such as for example, screws or nuts do not have to be used. The connection can be carried out by actuating a single actuation means, whereby the time requirement is reduced. A further advantage of the locking device is that no more tools are required since the actuation means can be actuated by the user by hand. The locking device can produce a secure, detachable mechanical connection between two components. In particular, the locking device can be used for connecting rigid as well as rotatable components and can securely transfer large mechanical forces as well as torques.

By providing the displacement device, which automatically moves the actuation means into the locking position, great effort is no longer required to connect the base body to the counter body. Furthermore, it is ensured that the base body is always fixed on the counter body with the same force, whereby a connection process with high repetition accuracy is guaranteed. The user thus does not require any knowledge, for example regarding the tightening torque prescribed by the manufacturer. In addition, the locking device enables a precise, secure and time-limited or permanent connection between the base body and the counter body. In particular, the locking device prevents an undesired release of the connection between the base body and the counter body during operation taking place, which requires checking the connection, for example after a determined time period.

The locking device can serve for connecting at least two components. The base body can be connected to a first component and the counter body to a second component. In this regard, the base body can be integrally connected to the first component such as for example by welding, adhering or pressing. Alternatively the base body can be detachably connected to the first component. The counter body can, analogous to the base body, be integrally connected to the second component by welding, adhering or pressing. Alternatively the counter body can be detachably connected to the second component. The connection of the two components can be carried out by locking the base body to the counter body. The detachable connection can be carried out in both cases by, for example, a screw connection.

The locking device can be used in the automotive field. In this case, the base body can be integrally or detachably connected to a wheel rim or a wheel retainer such as, for example, a wheel axle or a wheel hub, as the first component. Accordingly, the counter body can be integrally or detachably connected to the wheel retainer or the wheel hub. Alternatively or additionally, the locking device can be used in the aviation field. In particular, in this locking device, the base body can be connected to a wing or turbine component as the first component. Accordingly, the counter body can be connected to the turbine component or wing as the second component. In this field of application, either a polygonal or also a round configuration of the connecting components can be the optimal embodiment in each case. The polygonal configuration here prevents rotation of the mechanical connection, wherein the round configuration precisely allows this.

Naturally, the use of the locking device is not limited to the aforementioned automotive or aviation fields. Alternatively, the locking device can also be used for fitting, for example mixing drums in manufacturing or production processes.

In the context of the invention, the locking position of the locking means is understood as the position, in which the locking means locks and/or connects the base body and the counter body to each other. Furthermore, in the context of the invention, automatic movement of the actuation means is understood as a movement of the actuation means, which is effected by the displacement device. The actuation means can thus be moved into the locking position after the initialisation, without further influence from the user, solely due to the force exerted by the displacement device. Naturally, the user can support the movement of the actuation means by actuating the actuation means, in addition to the exertion of force by the displacement device.

In a particular embodiment, the locking device can have a tensioning device such as, for example a spring. The spring can be manufactured from steel or from plastics. The tensioning device can tension the displacement device transverse to a central axis, in particular in the direction of the centre of the base body. In particular, the tensioning device can tension the displacement device in the direction of the locking position of the actuation means. The base body can be a round or polygonal disc. In addition, the base body can be the mechanically bearing component, on which the movable components of the locking device are arranged. By providing the tensioning device, it can be ensured in a simple manner that a force is exerted on the actuation means by the displacement device in order to carry out an automatic movement of said actuation means.

The displacement device can be configured in a bistable manner and can thus occupy two stable positions. The displacement device can also be configured such that the displacement of the actuation means takes place solely due to mechanical components. This means that no electrical devices such as for example an actuator are used to displace the actuation means.

Following actuation of the actuation means, the actuation means moves from an unlocking position in the direction of the locking position. In the event that the user no longer actuates the actuation means and the actuation means has not reached the centre point, the actuation means can move back into the unlocking position or remain in the current position. In the event that the user no longer actuates the actuation means and the actuation means has exceeded the centre point, the displacement device can move into a stable second position and remain there due to the self-locking effect. The displacement device can be configured as an, in particular bistable folding device, wherein the folding device, in the case of exceeding the centre point, folds from a first folding position into a second folding position.

As a result, the connection process can take place in two phases in the locking device. In a first phase, the actuation of the actuation means is carried out by the user, by the latter exerting a force on the actuation means, as a result the actuation means is moved up to the centre point. After exceeding the centre point, a second phase can take place, in which the actuation means is automatically moved by the displacement device into the locking position.

In a particular embodiment, the displacement device can counteract or, in particular, prevent a movement of the unactuated actuation means from the unlocking position into the locking position or vice versa. It is thereby achieved that the actuation means cannot move automatically without a force effect by the user or the displacement device cannot move due to the force of its own weight or centrifugal force or other external mechanical forces. As a result, it is achieved that the actuation means remains in the current position.

The displacement device can have at least two plates, which are articulatedly connected to each other. Furthermore, the plates can be connected flush with each other. The plates can have a right-angled or quadratic form. Alternatively, the plates can have a semi-circular form. In this form, the plates can engage into each other as a form or counter form. A formation of the plates of this type is provided for the embodiments, in which there is less installation space available. Naturally, the plates can alternatively have another form. Furthermore, the displacement device can be articulatedly connected in each case to the actuation means and the base body. In the unlocking position and/or locking position of the actuation means, the at least two plates can be arranged in a self-locking manner with each other. It is thereby achieved in a simple manner that the displacement device can counteract or, in particular, prevent a movement of the unactuated actuation means from the unlocking position into the locking position or vice versa.

The tensioning device can be connected to the first plate, in particular directly connected to the base body. Furthermore, the tensioning device can be connected at the end remote from the first plate to the base body and thus exert a tensile stress on the first plate. Alternatively, the tensioning device can be connected to the second plate or to the second joint. Alternatively, the tensioning device can exert a compressive stress on the first plate and be connected at the end remote from the first plate to another component of the locking device.

The connection or locking between the base body and counter body can only be triggered when a triggering force, in particular a force exerted by the user is greater, according to the principle of the lever, than a force acting in the idle state. The idle force can emerge via the built-in tensioning device and the present position of the plates in relation to each other. A regulating means can be provided, which regulates the force effect or the lever stroke or both. It is thereby possible to change the required triggering force. This can occur by the tensioning force and thus the force on the first plate being changed. This can, for example take place via an adjustment functionality, which changes the tensioning force.

In a particular embodiment, the actuation means can have at least one slide to transfer the locking means into the locking position. The slide(s) can be configured integrally with a rest of the actuation means. Alternatively, the slide(s) and the rest of the actuation means can be configured in two or multiple pieces, wherein the slide(s) can be connected with the rest of the actuation means in a mechanically fixed or articulated manner. The slide(s) can be provided in the axial direction of the actuation means. In the event that a plurality of slides are provided, the slides can be arranged adjacent to each other in the circumferential direction of the actuation means. In the event that the actuation means does not have any slides, the actuation means can be directly connected to the locking means. In the event that the actuation means has at least one slide, the actuation means can be connected via the slide directly to the locking means.

The locking means can be arranged in the base body, in particular in one or a plurality of hole(s) of the base body. Furthermore, the base body can have one or a plurality of recess(es), into which the actuation means, in particular the slide(s) penetrate(s) at least partially to transfer the locking means into the locking position. The respective hole and the respectively associated recess are connected to each other.

The actuation means can be configured such that the actuation means protrudes with one or a plurality of appendages configured in each case as slides directly into the holes and thereby comes into direct contact with the locking means. Furthermore, the slides and the actuation means can be configured such that the latter are designed in each case as separate components, wherein the slides are in each case connected to the actuation means in a mechanically fixed or movable manner.

In addition, the actuation means and/or the slide of the actuation means can be configured such that the actuation means are not in contact with the locking means in the unlocking position. Furthermore, the actuation means and/or the slide of the actuation means can be configured such that the latter is/are, in particular directly in contact with the locking means and the latter transfer, in particular compress into the locking position. The part of the actuation means and/or slide pointing to the locking means can be configured conically, in particular can have a conical blank. In this way, a simple transfer or compression of the locking means into the locking position is achieved.

The locking means can be a cylindrical or spherical body. Naturally, the locking means can also have another form, provided it is ensured that the locking means can ensure a locking between the base body and the counter body.

In a particular embodiment, a sealant, in particular a rubber or elastomer sealant, can be provided, which merely seals the displacement device in the locking position of the actuation means. The sealant can be configured as a seal ring or as a lip seal or in another form and can be arranged on the base body or on the actuation means. The actuation means can have a web extending in the axial direction. The web can have a length such that the web only seals the displacement device in the locking position of the actuation means. The sealant can be directly arranged on the web. Alternatively, the sealant can be arranged on the base body, wherein the web enters into direct contact with the sealant when the actuation means is in the locking position.

The web can be configured circular in the cross-section and extend in the radial direction such that said web encloses the displacement device. As a result, the sealant seals the displacement device against penetration of moisture and dirt after a completed connection process. This ensures that the displacement device is not damaged or impaired by dirt in the functioning thereof.

Furthermore, the locking device can have a securing device. The securing device can serve for securing the actuation means in the locking position. By providing the securing device, it prevents the actuation means moving in an undesired manner from the locking position into the unlocking position and the connection thereby releasing. The securing device can have a securing bolt and an in particular eccentric cylinder disc coupled to the securing bolt. The securing bolt can be actuated by a user, wherein the cylinder disc can be rotated in the case of actuating the securing bolt.

In particular, the cylinder disc can be rotated into a position, in which an axial movement of the actuation means is prevented. The securing bolt can be configured so as to be detachable from the cylinder disc. By removing the securing bolt, it can be signalled to the user that the connection process is complete. At the same time, protection against theft is achieved since releasing the connection is only possible through the securing bolt. An optimisation of the signalling can be achieved after a successful connection process by colour markings being provided on the securing bolt to be removed and/or at least one signal flag being provided. In the event that one or a plurality of securing bolts have forgotten to be removed, this is clearly visible and the user recognises the danger.

The securing device can have, alternative to the securing bolt and the eccentric cylinder disc, a locking cylinder. The locking cylinder can be fixedly or movably connected to the actuation means and can be configured so as to be movable together with the actuation means. The locking cylinder can be axially or centrally fastened on the actuation means or the base body of the locking cylinder forms a continuous component with the actuation means. The locking cylinder can have a slot for a key on only one single side.

The securing bolt can, in this regard, be round in a corresponding configuration of the locking cylinder, or also correspond to the longitudinal form in the cross-section, which is known from cylinder locks and locking cylinders. The achieved securing function can be achieved by the pawls or the locking pins of the locking cylinder. By rotating the key, the pawl or the locking pin is unscrewed from a base body of the locking cylinder and moved into a blocking position. In this regard, the actuation means blocks in the lower axial position, whereby an unintended unlocking is avoided.

In the case of using the locking cylinder, a covering can be provided against penetrating moisture and dirt. This can, for example be a plastic cap or a corresponding lid, which is slid open, affixed or swivelled forward after removing the key.

In particular, in the case of using the locking device in the automotive field, preferably for connecting a wheel rim to a wheel retainer, the locking cylinder can be arranged on the actuation means such that the actuation means can slide through an axial and/or centrally arranged securing bolt in the case of the axial movement of the actuation means. This axial securing bolt can in turn be located in a central disc, which is held on the outer side of the wheel rim by the fastening struts. The outer ends of these fastening struts are fastened to the wheel rim. This fastening can take place by screw connections or by the central disc and the fastening struts forming one component with the wheel rim. Through this arrangement it is achieved that the locking cylinder can slide through the securing bolt and blocks the locking cylinder in the lower position of the actuation means when the pawl or locking pin of the locking cylinder is positioned by rotating the key under the central disc.

The locking device and/or counter body can have coding means, by means of which it is ensured that only a connection of components which fit together takes place. In the case of the coding means, these can be coding pins and/or correspondingly marked coding bores. Thus at least one coding pin can be provided on a side of the base body facing the counter body, said coding pin penetrating into a corresponding coding bore in the case of sliding the base body on the counter body. Naturally, the coding pin can alternatively be arranged on the counter body and the coding bore corresponding thereto on the base body. In the event that the coding has to be changed, blind stops can be provided, which can be flexibly installed on the corresponding coding bores for the coding pins.

In one particular embodiment, the base body can have a through-hole, into which the counter body can at least partially penetrate. The counter body penetrates into the through-hole when a locking and thus connection between the base body and the counter body is implemented.

The locking means can be positioned in the base body such that it engages in the locking position in the hollow space of the base body, in particular in the radial direction. In this regard, the locking means can at least partially penetrate or engage through the through-hole into a groove of the counter body arranged on the outer circumference of the counter body. In this regard the groove on the counter body is arranged such that, in the case of the counter body penetrating into the base body or the base body being slid onto the counter body, the groove is located opposite the recess and the locking means located therein.

The already mentioned groove can extend fully or partially around the pin of the counter body. Furthermore the counter body can have a mounting foot, from which the pin can protrude. The pin can at least partially penetrate into the through-hole of the base body when the base body is slid onto the counter body. Furthermore, the pin can be configured in the cross-section in a form complementary to the through-hole. The pin can be configured in the cross-section in a round or polygonal manner.

The polygonal pin serves for carrying out an anti-rotation lock such as, for example is necessary in the case of wheel fastenings. The round pin serves for carrying out rotatable connections.

A through-hole surface can be designed such that the base body can be manually slid on the counter body with as little friction as possible. This can, for example take place by lapping or by applying non-slip surfaces such as hard metals or plastics such as for example Teflon. The gap dimensions must be minimised or optimised to the extent that the base body can be manually slid on the base body with as little friction as possible.

In the case of the round design of the pin, the contact surface between the pin and the inner hole diameter of the through-hole can be configured as a bearing, for example as a slide bearing.

The locking device can be manufactured from different materials. If a cost-effective locking device is required, which is not subjected to overly high force effects and not to high or even low temperatures, it can be made from plastics. In the case of transferring high torques and high force effects, such as for example is the case of wheel fastenings, the locking device must be manufactured from metal, or alternatively from the combination of metal, in connection with ceramic materials or plastics materials or fibre-reinforced plastics.

Therefore, the base body and the counter body can, for example, be manufactured from metal in order to be able to receive larger forces. The displacement device can consist of plastic parts in order to utilise the cost advantages thereof for the manufacturing process or weight saving of the locking device. It is thus possible to optimise the locking device such that at any point on the locking device, the material, which is best suited for object to be solved, is used in connection with the cost guidelines.

The locking device can have in one exemplary embodiment four displacement devices, which are arranged offset by 90° in the circumferential direction. In addition, the displacement device can have four recesses and accordingly four slides. The locking device can also have another number of displacement devices, recesses and slides.

The displacement devices can also, however, be made precisely one-dimensional, two-dimensional, hexagonal, octagonal, etc., even a circular arrangement is possible up to a circular construction, which enables a force effect of 360 degrees. This means that a disproportionate increase of the connection forces can be carried out in the case of an identical construction size.

These embodiments or refinements can be used for applications, in the case of which particular criteria must be met. If an increased connection force is required, an increased number and arrangement of displacement devices up to a circular construction can be used. From economical aspects or in the case of special circumstances, only one single displacement can also be used in a one-dimensional manner.

In the case of using the locking device or the locking arrangement in the automotive field, these can be adaptively designed. For this purpose, the existing screw fastening for the wheels of vehicles are used to mount the locking device on the wheel retainer or wheel hub. Thus it is not the wheel rim, but the counter body which is screwed on the wheel retainer or wheel hub. Distancing rings, which are arranged between wheel retainer or wheel hub and the counter body, enable different installation depths of the locking device. Using these distancing rings, the track width of vehicles can be flexibly or changeably designed.

Further advantages emerge in that the achieved form and force-fit of the connection takes place always with the same quality due to the design. In this regard, the wheel is always fixed with the same force to the vehicle axle. The user thus does not need to have knowledge of the tightening torque prescribed by the manufacturer to fit the wheel since this is carried out by the rapid closure system. Due to the locking mechanics, a subsequent inspection of the correct fastening of the wheel is superfluous because, on the contrary to screw connections, there can no longer be tolerances in the connection forces. A subsequent check of the screw connections or a tightening up of the wheel screws or wheel nuts is dispensed with, as is required in the case of screw connections following a wheel change.

Due to the coding functionality, the wheel being fastened to a vehicle axle not provided is ruled out. This functionality is particularly welcomed in the case of directional tires. Due to the displacement device, time is saved in the case of a wheel change. The displacement device ensures that no auxiliary means or tools for the wheel change are required. Due to this function, no special physical requirements for a wheel change must be present in the case of the user, for example in the case of releasing tightly fitted wheel nuts.

Due to the signalling, for example by means of securing bolts, the user is informed after the connection process that the wheel has been correctly fitted. This can currently be shown in the case of fitting only via a special tool such as a torque key, which is not normally available to the average user. Due to the securing device, the unintentional actuation of the system is prevented. At the same time, protection against theft is achieved, which can currently only be carried out via an additional rim lock.

The aforementioned advantages enable the locking device to also be able to be used in motor racing since a time saving in the case of a wheel change is not only provided, but also professional and error-free fitting is ensured. Alternatively or additionally, the locking device can be used in the case of conventional vehicles so that a wheel change in vehicle workshops can be avoided, however a high connection quality is ensured.

In the case of using the locking device in the automotive field, the wheel rims together with the base body can be manufactured as cast metal or in forging technology from metal or optionally from plastics or fibre-reinforced plastics or ceramic. Alternatively, the base body and the wheel rim can in each case be manufactured as a separate component. These two components are preferably joined to each other by screw connections.

In the case of using the locking device for connecting mixing drums, the base body can be manufactured from steel or from aluminium alloys or other metals, in casting or forging technology. Alternatively, plastics or in the case of high temperatures, ceramic materials can also be used here. Alternatively, the base body can also be manufactured by machining production steps from metal or plastics.

Further aims, advantages, features and application possibilities of the present invention emerge from the following description of an exemplary embodiment by means of the drawings. All described and/or visually depicted features form, per se or in any reasonable combination, the subject matter of the present invention, also independently of the abstract thereof in the claims or reference to them.

### BRIEF DESCRIPTION OF THE DRAWINGS

Here are shown:

FIG. 1 shows a perspective depiction of a locking device according to the invention,

FIG. 2 shows a perspective depiction of a counter body,

FIG. 3 shows a side sectional view through the counter body depicted in FIG. 2,

FIG. 4 shows a side sectional view through the locking device and the counter body prior to a connection, wherein the locking device is connected to a wheel rim,

FIG. 5 shows a side sectional view through the locking device without a displacement device or counter body, wherein the locking device is connected to a wheel rim,

FIG. 6 shows a side view of the displacement device,

FIG. 7 shows a side sectional view through the locking device and the counter body following a connection, wherein the locking device is connected to a wheel rim,

FIG. 8 shows a top view of the locking device, wherein the locking device is connected to a wheel rim.

### DETAILED DESCRIPTION OF THE PREFERRED EMBODIMENTS

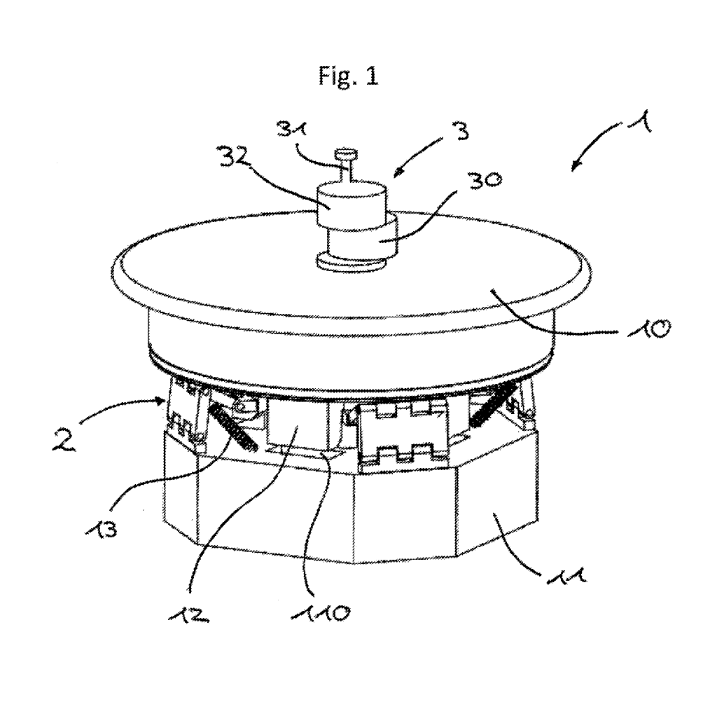

The locking device 1 shown in FIG. 1 has an actuation means 10, which is in particular directly connected to a securing device 3. The securing device 3 has a securing bolt 31, a cylindrical extension 32 and an eccentric cylinder disc 30. In this regard, the cylindrical extension 32 bears the securing bolt 31. In particular, the cylindrical extension 32 has a slot into which the securing bolt 31 can be detachably introduced. The diameter of the cylindrical disc 30 can correspond to the diameter of the cylindrical extension 32.

On the side of the actuation means 10 opposite the securing device 3, the actuation means is connected via one, or as depicted by way of example in FIG. 1, four mechanical displacement device(s) 2 in the form of folding devices to a base body 11. The actuation means 10 is movable relative to the base body 11. The displacement device 2 is coupled to the base body 11 via a tensioning device 13 in the form of a spring. The tensioning device 13 exerts a force on the displacement device 2 in the direction to a centre of the base body 11, transverse to the central axis thereof. Furthermore, the actuation means 10 has protruding slides 12 on the side remote from the securing device 3, thus on the side facing the base body, in the axial direction of the actuation means, or these slides are fixedly or movably connected to the actuation means 10. The base body 11 can be connected to a first component to be connected, not shown in FIG. 1. The connection can take place integrally or detachably. The base body 11 has recesses 110, into which the slides 12 can engage in the case of actuating the actuation means 10. Naturally, the slides 12 can again exit the recess 110 in the case of unlocking. In the exemplary depiction of FIG. 1, four slides 12 are present, wherein however, only two slides 12 are graphically depicted.

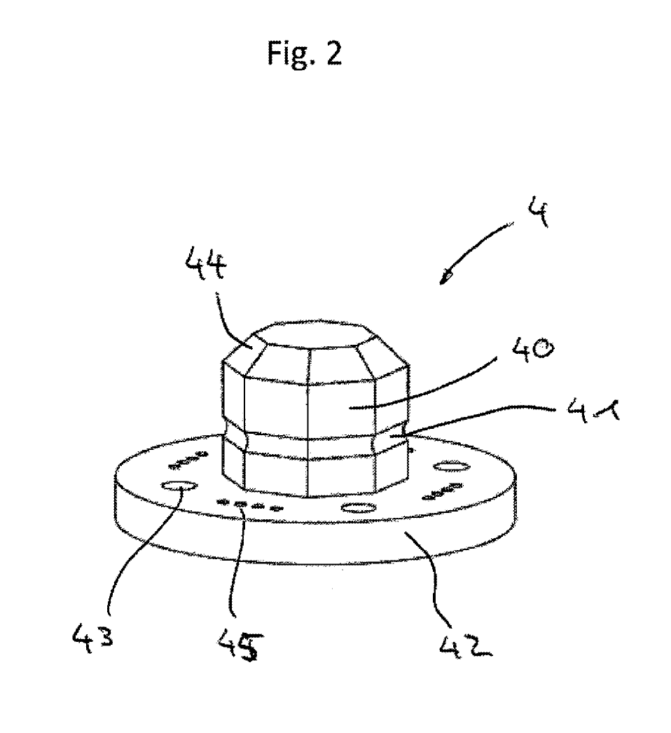

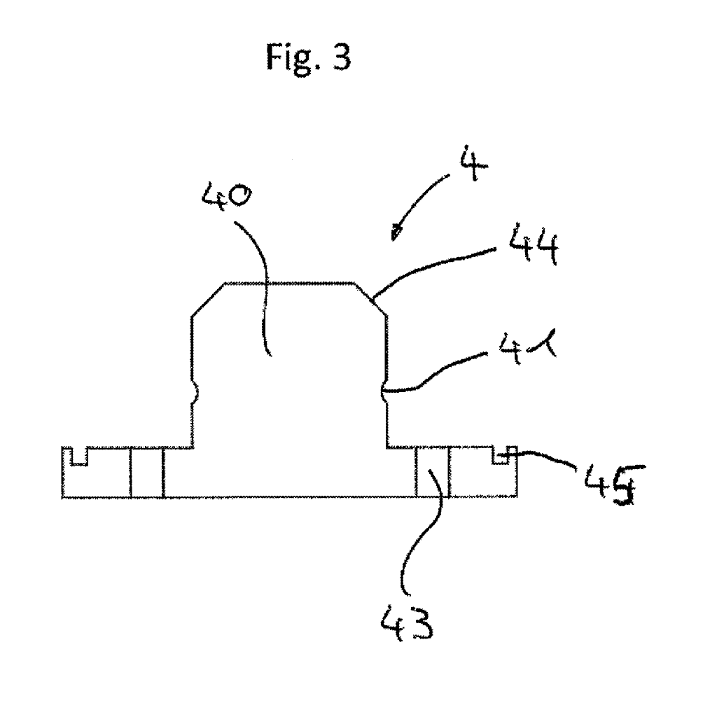

The locking device depicted in FIG. 1 can be connected to a counter body 4 depicted in FIGS. 2 and 3. The counter body 4 has a mounting foot 42 and a pin 40 extending from the mounting foot 42. The pin 40 can be configured in a hexagonal manner in the cross-section. The mounting foot 42 can be fixedly connected to the pin 40 or forms, together with the pin, a homogenous workpiece. The mounting foot 42 has at least one through-hole 43, via which the mount foot 42 can be detachably connected to a second component to be connected, which is not shown. Naturally, an embodiment can also be realised, in which the counter body 4 is integrally connected to the second component, which is not shown. The pin 40 together with the mounting foot 5 is preferably manufactured from metal or plastics or fibre-reinforced plastics or ceramic.

The pin 40 has a circumferential groove 41, which serves to lock a subsequently explained connection process. Furthermore, the pin 40 has, on the end thereof remote from the mounting foot 42, a bevel 44 for each edge. This serves for easier introduction of the counter body 4 into the locking device 1. At least one coding bore 45 is provided in the mounting foot 42, into which a coding pin, arranged on the locking device and not shown, can be engaged. The coding bore 45 serves to ensure that in each case associated counter bodies 4 and locking devices 1 are connected to each other.

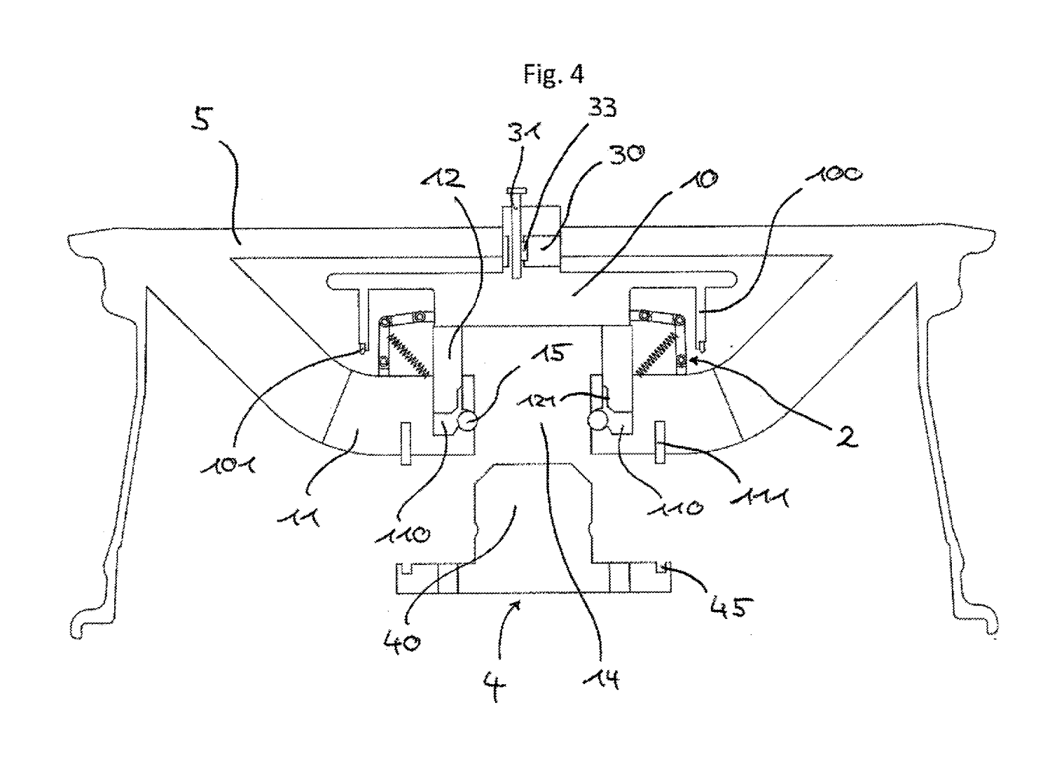

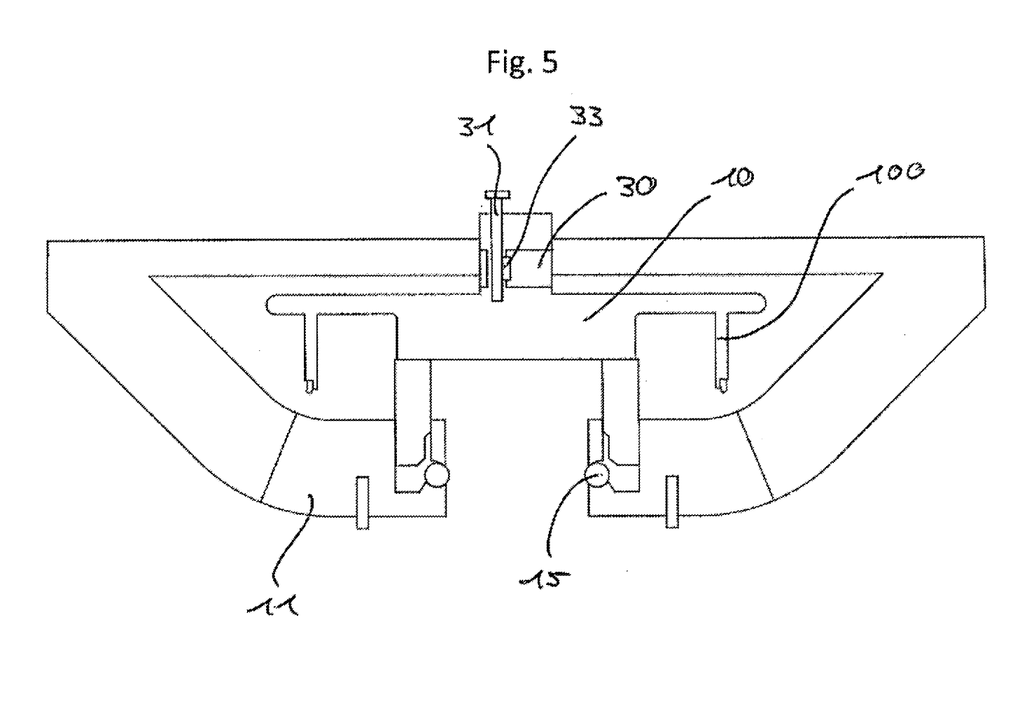

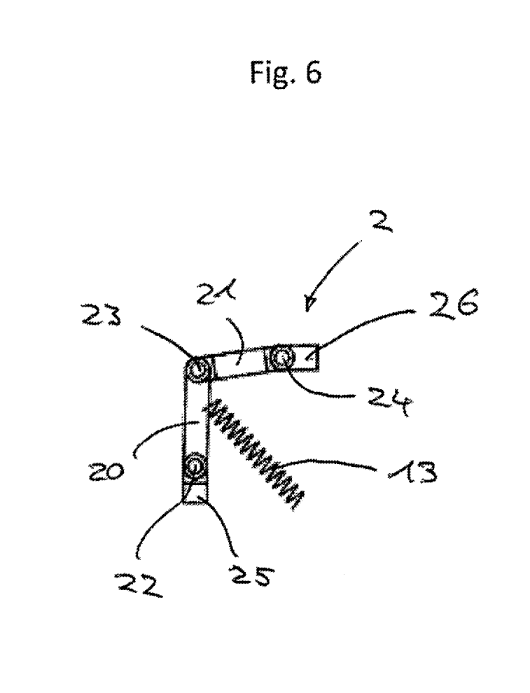

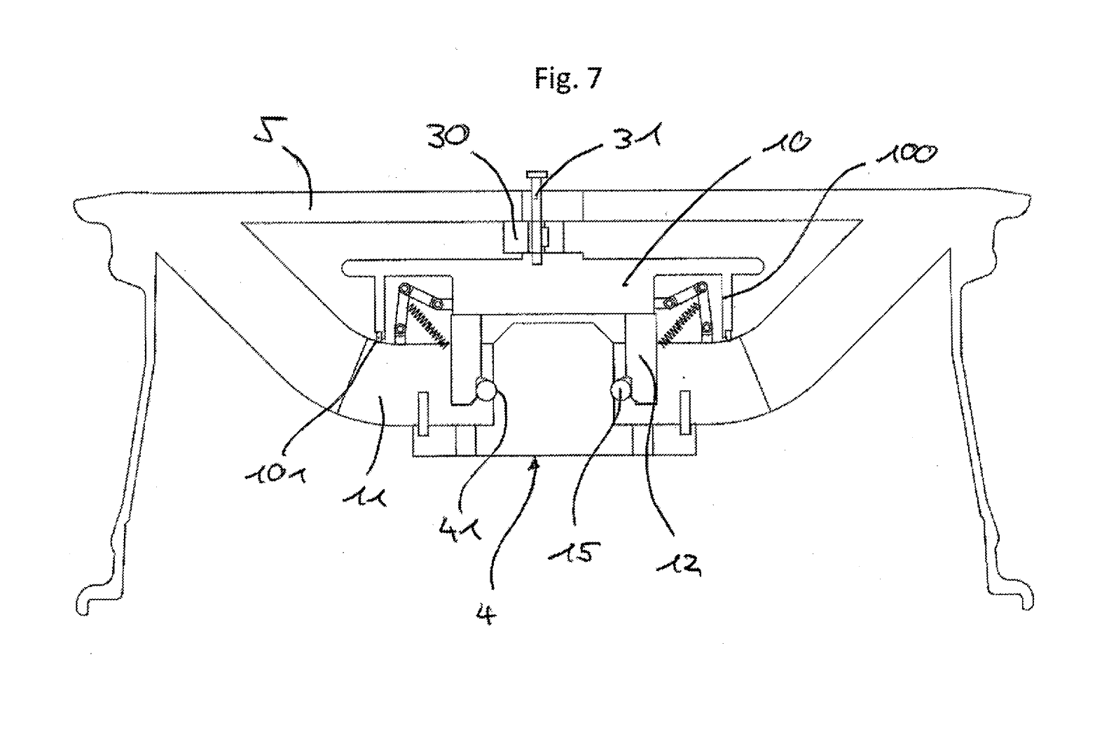

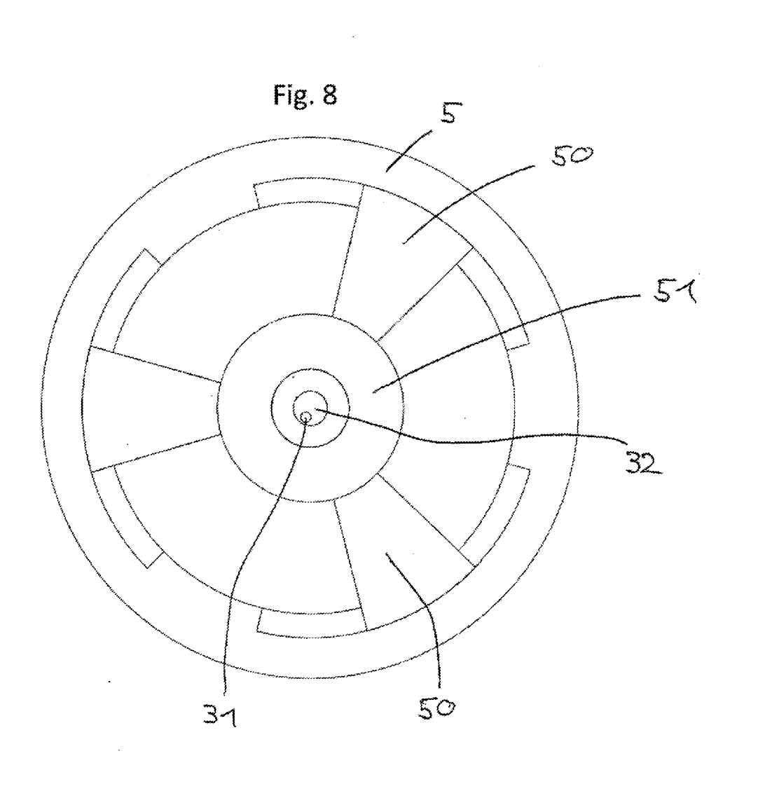

In FIGS., 4, 5, 7 and 8, an embodiment is shown, in which the locking device 1 is connected to a wheel rim 5. In this regard, the FIGS. 4 and 5 show a state before the locking device 1 is connected to the counter body 4 and FIG. 7 shows a state, after the locking device 1 is connected to the counter body 4. FIG. 8 shows a top view on the locking device 1 connected to the wheel rim. In FIG. 6, a detailed view of the displacement device 2 is depicted with the individual components thereof.

The use of the locking device 1 is not limited to the connection to the wheel rim such that the subsequent claims are not related only to the use of the locking device 1 for wheel rims 5, but to all possible areas of use.

The base body 11 of the locking device 1 is integrally connected to the wheel rim 5, in particular a rim diameter. Naturally, an embodiment which is not shown, can also be realised, in which the base body 11 is detachably connected to the wheel rim 5 by means of, for example a screw connection. Furthermore, the mechanical connection can, for example, take place by rivets or bolts. Coding pins 111 are provided on the end of the base body 11 pointing to the counter body 4, which engage into the corresponding coding bores 45 of the counter body 4 in the case of coupling the counter body 4 to the locking device 1.

The base body 11 has a through-hole 14, into which the counter body 4 can at least partially engage, in particular the pin 40 of the counter body 4. The through-hole 14 can be configured in an octagonal manner in the cross-section. The recess 110 is provided in the radial direction adjacent to the through-hole 14, with which the slide 12 of the actuation means 10 engages. A movable locking means 15, for example in the form of a sphere is provided in the base body 11. The locking means 15 is arranged in a hole of the base body 11, wherein the hole is connected to the recess 110. The slide 12 protrudes into this recess 110, said slide being fastened to the actuation means 10 in a mechanically fixed or movable manner, or alternatively being part of the actuation means 10.

The locking means depicted in FIG. 4 is located in an unlocking position. In this position, the locking means is not in contact with the slide 12. The slide 12 has, on the end thereof pointing to the locking means 15, a conical blank 121, by means of which the locking means 15 can be compressed in the radial direction into the through-hole 14. The embodiment depicted by way of example in FIG. 4 contains four slides 12 and four locking means 15 in the form of four spheres or rollers.

As already mentioned, the actuation of the locking means 15 according to the invention takes place directly by the actuation means 10 or via the slide 12. In this regard, the design according to the invention of the actuation means 10 and slides 12 takes place in the following ways:

1. The actuation means 10 forms, together with the slide 12, a homogenous continuous workpiece or component. In this regard, the workpiece can for example be manufactured by means of casting technology, forging technology or by machining production processes.
2. The actuation means 10 and the slides 12 are manufactured in each case as separate components, which are mechanically movable or fixedly connected to each other.

The actuation means 10 has a web 100 which is circular in the cross-section. The web extends in the radial direction to the base body 11 further than the displacement device 2 such that the displacement device 2 is arranged within a space delimited by the web 100. The web 100 extends in the axial direction of the actuation means 10 such that the web is not in contact with the base body 11 when the actuation means is not actuated, thus in the unlocking position. A sealant 101 is arranged on the end of the web 100 pointing to the base body 11.

The securing device 3 has a securing pin 33, which is connected to the securing bolt 31 and the eccentric cylinder disc 30. This means that in the case of a rotation of the securing bolt 31, the eccentric cylinder disc 30 also rotates.

The displacement device 2 shown in FIG. 6 has a first plate 20, which is connected to the base body 11 depicted in FIG. 5 via a first joint 22. In this regard, the first joint 22 is arranged on a fastening plate 25, which is connected directly to the base body 11. Furthermore, the displacement device 2 has a second plate 21, which is connected to the first plate 20 via a second joint 23. The second plate 21 is connected to the actuation means 10 depicted in FIG. 5 via a third joint 24 at the end remote from the second joint 23. In this regard, the third joint 24 is directly connected to the actuation means 10 via a second fastening plate 26. The tensioning device 13 is directly connected to the first plate 20. The first and/or third joint 22, 24 can be arranged offset by 90° to each other in the circumferential direction.

Optionally to the exemplary depiction of FIG. 6, the tensioning device 13 can also be connected to the second plate 21 or to the second joint 23. Thus these arrangements also correspond to the design according to the invention.

In FIG. 7, the locking device is depicted in a position, in which the locking device is connected to the counter body 4. The counter body 4 is arranged in the through-hole. The actuation means 10 is located in a locking position, in which the slides 12 of the actuation means 10 are in contact with the locking means 15. The slides 12 compress the locking means 15 into the locking position. In this position, the locking means 15 engages into the groove 41 of the counter body 4.

The actuation means 10 is moved in the axial direction such that the sealant 101 is in contact with the base body 11. Furthermore, the securing device 3 is actuated such that a return movement of the actuation means from the locking position depicted in FIG. 7 to the unlocking position depicted in FIG. 4 is not possible. The securing bolt 31 and thus the eccentric cylinder disc 30 have been rotated proceeding from the position depicted in FIG. 4 such that the eccentric cylinder disc protrudes in the radial direction from a securing bore and abuts against a central disc such that an axial movement of the actuation means is not possible.

In FIG. 8, a top view on the locking device is shown, which is connected to the wheel rim. At least two fastening struts 50 are formed on the wheel rim 5 or screwed with the wheel rim 5. In this regard, a central disc 51 is present in the middle of the at least two fastening struts 50, in which central disc a central securing bore is arranged. The outer ends of the fastening struts 50 are fastened to the wheel rim 5. This fastening can take place by screw connections or in that the central disc 51 and the fastening struts 50, together with the wheel rim 5, form one component. The preferred material for realising these components is metal or plastics or fibre-reinforced plastics. At least one part of the conical extension 32 and the eccentric cylinder disc 30 can slide in the securing bore in the axial direction.

For applications, in which the locking device 1 must be designed so as to be rotatable with respect to the pin 40 of the counter body 4, both the through-hole 14 and the pin 40 can be configured in a round manner. In order to improve the rotatable bearing, contact surfaces can in this regard be configured between the through-hole 14 and the pin 40 as slide bearings.

Below, the connection process will be explained in detail, wherein it proceeds from the position depicted in FIG. 4, in which the locking device 1 is not connected to the counter body 4.

In the position depicted in FIG. 4, the actuation means 10 is located in the unlocking position, in which the actuation means or the slides 12 of the actuation means 10 are not in contact with the locking means 15. In the unlocking position, no automatic movement of the actuation means 10 takes place due to, for example, the component's own weight since this movement counteracts a self-locking effect between the first and second plate 20, 21 of the displacement device. In other words, the friction between the first and second plate 20, 21 is greater than the component's own weight such that no automatic movement of the actuation means 10 takes place.

Since a connection or locking between the locking device 1 and the counter body 4 is produced, the user must position the locking device 1 on the counter body, in particular up to the stop. The user must subsequently exert a force on the actuation means 10, which displaces the actuation means in the axial direction. The force must be greater than the friction force between the first and second plate 20, 21 and the spring force of the tensioning device 13 of the displacement device. In the event that this occurs, the actuation means 10 moves axially in the direction of the base body 11 and thus into the locking position. In the case of the movement of the actuation means 10, the slides 12 also automatically move in the direction of the respective locking means 15 inside the recess 110. The user can also exert the force on the cylindrical extension 32 protruding from the central disc 51 in order to effect a movement of the actuation means 10. The cylindrical extension 32 and the eccentric cylinder disc 30 move inside the securing bore.

In the case of actuating the actuation means 10, a deflection of the forces takes place through the joints 22, 23, 24. These form the movable pivot points, with which the two plates 20, 21 of the displacement device 2 are in each case connected to the base body 11 and to the actuation means 10. Thus the externally supplied force is deflected and acts against the acting spring force of the tensioning device 13. The second plates 21 are pressed down if the force externally supplied by the user on the actuating means 10 is greater than the spring force generated by the four tensioning devices 13.

In this regard, a force on the actuation means 10 must be exerted by the user until the actuation means has been moved beyond the centre point. The second joint 23 and a force engagement point of the tensioning device 13 with the first plate 20 are in the centre point in the same plane. In the case of a movement of the actuation means 10 in the axial direction, the cylindrical extension 32 and the eccentric cylinder disc 30 also simultaneously move inside the securing bore of the central disc 35 in the same direction as the actuation means 10.

After exceeding the centre point, a force exerted by the displacement device 2 on the actuation means 10 effects the actuation means 10 to automatically move into the locking position. The force substantially results from the fact that the tensioning device 13 exerts a force on the displacement device 2 directed in the direction of the centre of the base body 11. If the centre point has now been exceeded and the user further exerts a force on the actuation means, the acting forces mount up and the plates 20, 21 of the displacement devices 2 are pressed together in a V-shape and in the direction of the actuation means 10. In addition, the displacement device 2 is folded down following the exceeding of the centre point. The user does not have to exert any further force on the actuation means after exceeding the centre point in order to effect a movement of the actuation means 2 into the locking position. Naturally, the user can also further exert a force.

The first and second plate 20, 21 are again arranged in relation to each other in the locking position of the actuation means such that a self-locking effect between said plates prevents an automatic return movement, caused without an outer force effect, of the actuation means into the unlocking position. In the locking position, the slides 12 of the actuation means 10 are in contact with the respective locking means 15. In particular, the slides 12 compress the locking means 15 in the radial direction from the base body 10 into the through-hole 14. Since the counter body 4 is arranged in the through-hole 14, the locking means 15 reaches at least partially into the groove 41 of the counter body 4.

A connection and locking between the locking device 1 and the counter body 4 can be carried out by the engagement of the locking means 15 into the groove 41. Accordingly, a connection and locking between a first component can be carried out, such as for example the wheel rim, which is connected to the locking device 1 and a second component, such as for example a wheel retainer or wheel hub, which is not depicted.

In order to carry out the securing beyond the aforementioned self-locking effect such that it is ensured that the actuation means 10 does not automatically move into the unlocking position in an undesired manner, the securing device 3 can be actuated. In particular, the securing bolt 31 can be introduced into the slot of the cylindrical extension and rotated. Due to the rotation of the securing bolt 31, the eccentric cylinder disc 30 rotates such that the eccentric cylinder disc protrudes in the radial direction beyond the securing bore provided in the central disc 35. In particular, the eccentric cylinder disc 30 is positioned below the inner side of the central disc 35, whereby the eccentric cylinder disc rests on the inner side of the central disc 35. This leads to the blocking of the entire locking mechanism in the locking position.

In addition, the sealant 101 arranged on the web 100 is in contact with the base body 11 in the locking position of the actuation means 10. A sealing of the locking device 2 is thereby achieved. In this regard, a pressing force of the sealant 101 is notably smaller than a retaining force of the displacement devices 2.

### LIST OF REFERENCE NUMERALS

1 Locking device
2 Displacement device
3 Securing device
4 Counter body
5 Wheel rim
10 Actuation means
11 Base body
12 Slide
13 Tensioning device
14 Through-hole
15 Locking means
20 First plate
21 Second plate
22 First joint
23 Second joint
24 Third joint
25 First fastening plate
26 Second fastening plate
30 Eccentric cylinder disc
31 Securing bolt
32 Cylindrical extension
33 Securing pin
40 Pin
41 Groove
42 Mounting foot
43 Through-bore
44 Bevel
45 Coding bore
50 Fastening strut
51 Central disc
100 Web
101 Sealant
110 Recess
111 Coding pin
121 Conical blank

1. Locking device (1) having a base body (11), a locking means (15) for locking the base body (11) to a counter body (4), an actuation means (10) movable relative to the base body (11), said actuation means being able to be brought into contact with the locking means (15), and at least one displacement device (2), characterised in that the displacement device (2) is connected to the actuation means (10) and to the base body (11) and in the case of actuating the actuation means (10), the actuation means automatically moves into a locking position, wherein the actuation means (10) transfers the locking means (15) into a locking position and is in contact with the locking means (15) in the locking position, wherein the displacement device (2) automatically moves the actuation means (10) into the locking position only after exceeding a centre point.

2. Locking device (1) according to claim 1, characterised by a tensioning device (13), which tensions the displacement device (2) transverse to a central axis of the actuation means (10).

3. Locking device (1) according to claim 1, characterised in that the displacement device (2) counteracts a movement of the unactuated actuation means (10) from an unlocking position into the locking position or vice versa.

4. Locking device (1) according to claim 1, characterised in that the mechanical displacement device (2) has at least two plates (20, 21), which are articulatedly connected to each other.

5. Locking device (1) according to claim 4, characterised in that the at least two plates (20, 21) are arranged in a self-locking manner in relation to each other in the unlocking position and/or in the locking position of the actuation means (10).

6. Locking device (1) according to claim 2, characterised in that a tensioning device (13) is connected to a first plate (20) connected to the base body (11) or to a second plate (21) or to a second joint (23).

7. Locking device (1) according to claim 1, characterised in that the actuation means (10) has at least one slide (12), in particular at least one slide (12) connected to said actuation means in order to transfer the locking means (15) into the locking position, wherein the locking means (15) is arranged in the base body (11).

8. Locking device (1) according to claim 1, characterised in that the base body (11) has a recess (110), into which the actuation means (10), in particular the slide, (12) at least partially penetrates in order to transfer the locking means (15) into locking position.

9. Locking device (1) according to claim 1, characterised by a sealant (101) arranged on the actuation means (10), which merely seals the displacement device (2) in the locking position of the actuation means (10).

10. Locking device (1) according to claim 1, characterised by a securing device (3) for securing the actuation means (10) in the locking position.

11. Locking device (1) according to claim 1, characterised in that the base body (11) has a through-hole (14), into which the counter body (4) can at least partially penetrate.

12. Locking device (1) according to claim 11, characterised in that this through-hole (14) constitutes a polygon and the pin (40) of the counter body (4) has the polygonal form suitable therefor.

13. Locking device (1) according to claim 1, characterised in that the base body (11) is connectable or, in particular is integrally connected to a wheel rim or to a wheel retainer and/or the counter body (4) is connectable or, in particular is integrally connected to another wheel rim or wheel retainer.

14. Locking arrangement having a locking device according to claim 1 in combination with a counter body (4), which is connectable or connected to the base body (11).

15. Locking arrangement according to claim 14, characterised in that the counter body (4) has an, in particular, circumferential groove (41), into which the locking means (15) penetrates for locking.

16. Locking arrangement according to claim 15, characterised in that the counter body (4) has a mounting foot (42), from which a pin (40) protrudes, which at least partially penetrates into the through-hole (14) of the locking device (1).

17. Locking arrangement according to claim 14, characterised in that the contact surfaces of the through-hole 14 to the pin 40 are configured as slide bearings.
